(19) United States
(12) Patent Application Publication
(10) Pub. No.: US 2026/0292075 A1
(43) Pub. Date: Sep. 24, 2026

(54) IMAGE FORMING APPARATUS, CONTROL METHOD THEREFOR, AND STORAGE MEDIUM

(71) Applicant: CANON KABUSHIKI KAISHA, Tokyo (JP)

(72) Inventor: DAIKI TAKAHASHI, Kanagawa (JP)

(21) Appl. No.: 19/563,809

(22) Filed: Mar. 11, 2026

(30) Foreign Application Priority Data
Mar. 24, 2025 (JP) 2025-049102

(51) Int. Cl. H04N 1/00

(52) U.S. Cl. CPC H04N 1/00084; H04N 1/00076; H04N 1/00087

(57) ABSTRACT

In a case where a packaging material is present inside a printer, the printer is configured to guide a user to perform an apparatus setting operation subsequent to performing removal of the packaging material and a print preparation setting operation on the printer. In a case where no packaging material is present in the printer, the printer is configured to guide the user to perform the print preparation setting operation subsequent to performing the apparatus setting operation.

### BACKGROUND

### Field of the Technology

The present disclosure relates to an initial installation of an image forming apparatus.

### Description of the Related Art

Image forming apparatuses such as an inkjet printer and a copying machine perform an operation for initial installation after the power is turned on for the first time. The initial installation includes print preparation settings necessary for image forming processing such as ink setup, sheet loading, and print head position adjustment. In addition, the initial installation also includes important settings to be set first to execute the initial installation such as a language setting and a country setting, and basic settings required to use an image forming apparatus, such as a connection setting with an external device and a license agreement setting. Further, an image forming apparatus in a packaged state may be protected by a fixing member so that internal members are not damaged or moved due to impact or the like during transportation or storage.

Incidentally, operators who perform the initial installation have recently become more diverse. In addition to a case where an initial installation service is used in which the initial installation is performed by a maintenance personnel of a manufacturer of an image forming apparatus or delivery staff of a dealer, there is also a case where a user who has purchased the image forming apparatus performs the initial installation operation by himself/herself.

In the case where the user performs the initial installation operation by himself/herself, the initial installation is not necessarily performed by an operator having specialized knowledge or having knowledge about the image forming apparatus. In other words, there is a possibility that the user may perform the initial installation in a state of not knowing what initial installation items are to be performed, in what order the initial installation items are to be performed, and what items remain.

Japanese Patent Laid-Open No. 2006-201481 describes a technique for improving user convenience by causing a display unit of an image forming apparatus to display a status indicating the progress in processes of an initial installation operation.

However, in the related art, the status of the initial installation operation is merely displayed, and it is not possible to provide appropriate guidance in accordance with the operation status of an operator performing the initial installation. In addition, no consideration is given to separation between print preparation settings that require a physical operation on the image forming apparatus and apparatus settings that do not involve any physical operation. Thus, particularly in a case where the user performs the initial installation operation by himself/herself, if the print preparation settings and apparatus settings are not separated and the user is guided to alternately perform the print preparation settings and the apparatus settings, the initial installation operation becomes complicated, and there is a possibility that the user cannot smoothly perform the initial installation operation.

### SUMMARY

The present disclosure is directed to providing a mechanism that enables an operator to smoothly complete an initial installation operation while reducing a sense of awkwardness in operation perceived by the operator.

According to an aspect of the present disclosure, an image forming apparatus includes at least one memory that stores a set of instructions, and at least one processor that executes the instructions causing the image forming apparatus to perform operations comprising a first determination unit configured to determine whether a packaging material is present inside the image forming apparatus, and a control unit configured to control an order of guidance for an initial installation operation for the image forming apparatus in accordance with a result of determination, wherein the initial installation operation includes a first operation related to hardware and a second operation related to software, and wherein, in a case where the packaging material is present inside the image forming apparatus, the control unit guides a user to perform the second operation subsequent to performing removal of the packaging material and the first operation and, in a case where the packaging material is not present inside the image forming apparatus, the control unit guides the user to perform the first operation subsequent to performing the second operation.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an example of a hardware configuration of an image forming apparatus.

FIG. 2 is a schematic view illustrating an example of the image forming apparatus.

FIG. 3 is a schematic view illustrating an example of an internal structure of the image forming apparatus.

FIG. 4 is a flowchart illustrating an example of initial installation processing according to the first embodiment.

FIG. 5 is a flowchart illustrating an example of initial installation processing according to a second embodiment.

FIGS. 6A and 6B are a flowchart illustrating an example of initial installation processing according to a third embodiment.

FIGS. 7A, 7B, and 7C each illustrate an example of a screen display of the image forming apparatus during the initial installation processing.

FIG. 8 is a table illustrating an example of an operation category for each item for the initial installation processing.

### DESCRIPTION OF THE EMBODIMENTS

Embodiments of the present disclosure will be described in detail below with reference to the attached drawings. The following embodiments do not limit the present disclosure as set forth in the appended claims, and not all combinations of the features described in the embodiments are essential to the solution of the present disclosure.

### First Embodiment

### Hardware Configuration of Printer

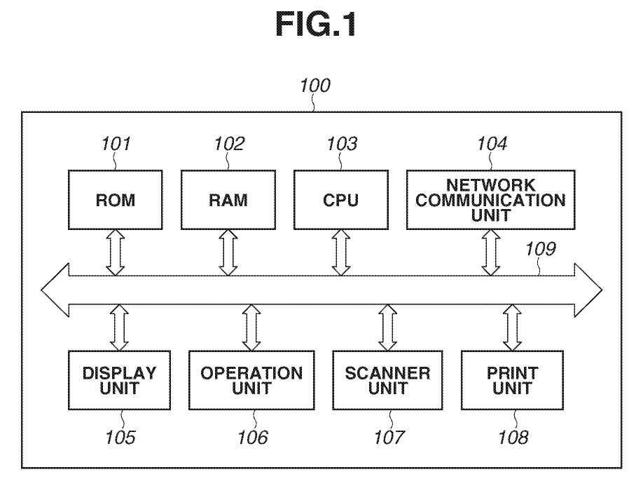

A configuration of a printer 100, which is an example of an image forming apparatus, will be described with reference to FIGS. 1 to 3. In a first embodiment, the printer 100 is an inkjet printer that performs printing with ink. However, the printer 100 is not limited to this configuration. An electrophotographic printer that performs printing with toner may be used as the printer 100. In such a case, ink-related processing such as ink installation, to be described below, is executed as toner-related processing such as toner installation.

FIG. 1 is a block diagram illustrating an example of a hardware configuration of the printer 100 as an image forming apparatus according to the first embodiment.

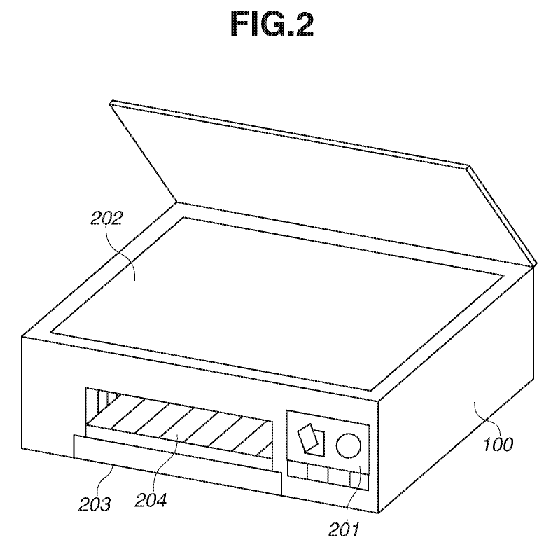

FIG. 2 is a schematic view illustrating an example of the printer 100.

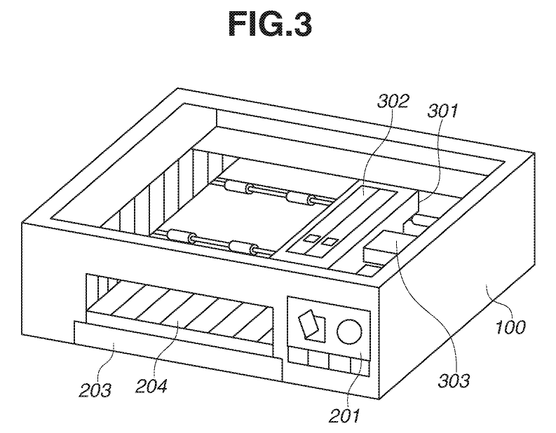

FIG. 3 is a schematic view illustrating an example of an internal structure of the printer 100.

The printer 100 includes a read-only memory (ROM) 101, a random access memory (RAM) 102, a central processing unit (CPU) 103, a network communication unit 104, a display unit 105, an operation unit 106, a scanner unit 107, and a print unit 108 that performs image forming processing.

The ROM 101 is a flash ROM and stores fixed data such as a control program to be executed by the CPU 103, data tables, and an operating system (OS) program. In the first embodiment, each control program stored in the ROM 101 performs software execution control such as scheduling, task switching, or interrupt processing under control of an embedded OS stored in the ROM 101.

The RAM 102 includes a Dynamic Random Access Memory (DRAM) that requires backup power. The RAM 102 is also used as a main memory and a work memory for the CPU 103, and serves as a reception buffer for temporarily storing print information received from a personal computer (PC) or the like and stores various types of information. The RAM 102 also stores image data and the like received by the network communication unit 104.

The CPU 103 functions as a system control unit and is a central processing unit for controlling each unit in the printer 100. The CPU 103 reads out a program stored in the ROM 101 or the like, loads the program into the RAM 102, and executes the program, thereby implementing various types of control.

The network communication unit 104 connects to a network such as the Internet or a local area network, and communicates with another apparatus.

The display unit 105 is composed of a light-emitting diode (LED), a liquid crystal display (LCD), or the like, and displays data and issues a notification of the state of the printer 100.

The operation unit 106 includes a switch and hardware keys for a user to perform various input operations. In addition, as with a touch panel 201 illustrated in FIG. 2, a configuration may be adopted in which the display unit 105 functions as an operation unit for performing an input operation and the like.

The scanner unit 107 implements a scan function. In the printer 100, the scan function is implemented by the scanner unit 107, and a print function is implemented by the print unit 108. The CPU 103 controls the scanner unit 107 to optically scan a document set on a glass-like transparent platen glass 202, convert the document into electronic data, and transmit image data further converted into a designated file format to an external apparatus via a network or store the image data in the RAM 102. In the first embodiment, a flatbed scanner with a platen glass is used. Alternatively, an automatic document feeder type scanner that automatically feeds documents placed on a document feeder tray and scans the documents may be used.

The print unit 108 implements the print function. The print unit 108 forms an image on a recording medium such as a sheet, with colorant (recording material) such as ink, based on information stored in the ROM 101 or the RAM 102 and a print job received from a PC or the like, and outputs a print result. The print unit 108 feeds recording media one by one from a sheet feed port 203 on which recording media can be stacked. The print unit 108 includes, for example, print heads for four colors, namely, yellow, cyan, magenta, and black. Each print head, to which an ink tank 302 is attached, ejects colorant of the corresponding color to form an image. Specifically, each print head forms an image on a recording medium by ejecting colorant from the print head while operating a carriage 301 on which the ink tank 302 is mounted in a direction perpendicular to a conveyance direction of the recording medium. A print result of the image formed on the recording medium by the print unit 108 is discharged from a print result discharge port 204.

Further, a copy function is implemented by transferring image data generated by scanning a document with the scanner unit 107 to the print unit 108, and causing the print unit 108 to record an image on a recording medium based on the image data.

The units described above are interconnected via a bus 109 so that data can be mutually transmitted and received.

Note that a packaging material 303 is attached to protect each print head and the carriage 301 from vibration and impact during delivery, and is disposed on a movement path of the carriage 301. Accordingly, the user removes the packaging material 303 during an initial installation operation. In a state where the packaging material 303 is not removed, the carriage 301 cannot perform a moving operation.

### Initial Installation Processing

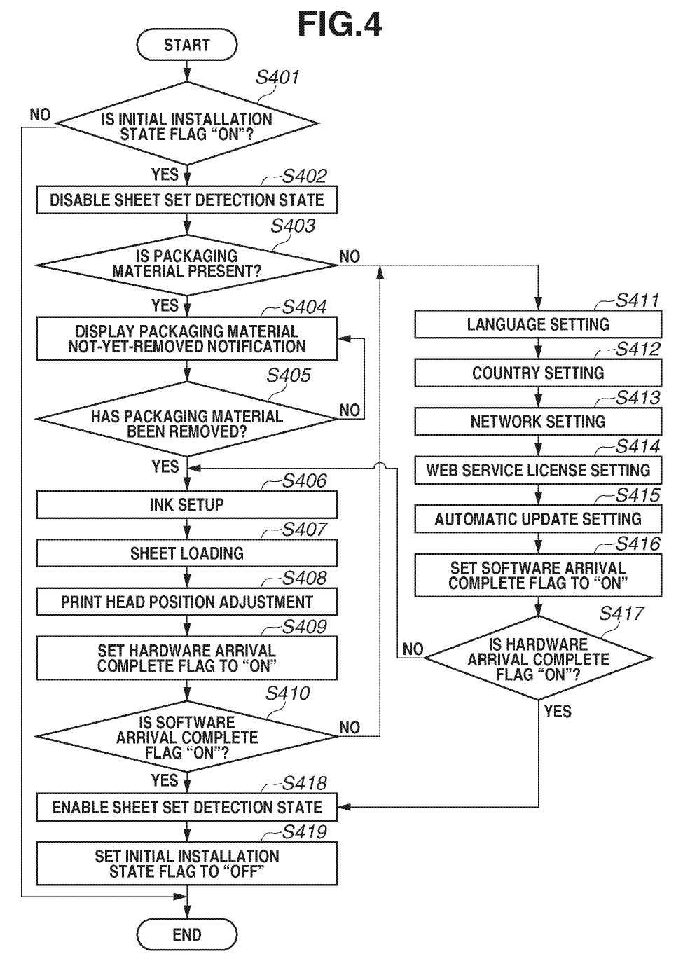

FIG. 4 is a flowchart illustrating an example of initial installation processing to be executed by the printer 100 according to the first embodiment. A series of processes illustrated in the flowchart of FIG. 4 is performed by the CPU 103 of the printer 100 loading a program code stored in the ROM 101 or the like into the RAM 102 and executing the program code. The processing in this flowchart is performed at a timing when the user turns on the power after purchasing the printer 100 and opening the package thereof.

First, in step S401, the CPU 103 determines whether the printer 100 is in an initial installation state. The determination as to whether the printer 100 is in the initial installation state is made based on an initial installation state flag stored in the ROM 101. This flag has either a value "ON", which indicates that the printer 100 is in the initial installation state, or a value "OFF", which indicates that the printer 100 is not in the initial installation state, i.e., in a state where the initial installation is complete. An initial value of the initial installation state flag is set to "ON", for example, at the time of factory shipment.

If the value of the initial installation state flag is "OFF", the CPU 103 determines that the initial installation is complete (NO in step S401), and the processing in the flowchart ends.

In this case, the processing transitions not to the initial installation, but to a normal start-up control.

On the other hand, if the value of the initial installation state flag is "ON", the CPU 103 determines that the printer 100 is in the initial installation state (YES in step S401), and the processing proceeds to step S402.

In step S402, the CPU 103 disables a sheet set detection state of the printer 100. This is for the purpose of suppressing unnecessary display during the initial installation operation, and preventing, when the user places sheets on the sheet feed port 203, execution of display associated with the sheet set detection.

Next, in step S403, the CPU 103 determines whether the packaging material 303 is present (is not removed) in the printer 100. This determination is made based on whether, for example, the carriage 301 is actually moved when an operation for moving the carriage 301 is performed. If the carriage 301 is actually moved, the CPU 103 determines that the packaging material 303 is not present (is removed). If the carriage 301 cannot be actually moved, the CPU 103 determines that the packaging material 303 is present (is not removed).

If the CPU 103 determines that the packaging material 303 is not present (has been removed) (NO in step S403), the processing proceeds to step S411. The processing of step S411 and subsequent steps will be described below.

On the other hand, if the CPU 103 determines that the packaging material 303 is present (is not removed) (YES in step S403), the processing proceeds to step S404.

In step S404, the CPU 103 displays a packaging material not-yet-removed notification on the display unit 105 since the packaging material 303 has not been removed.

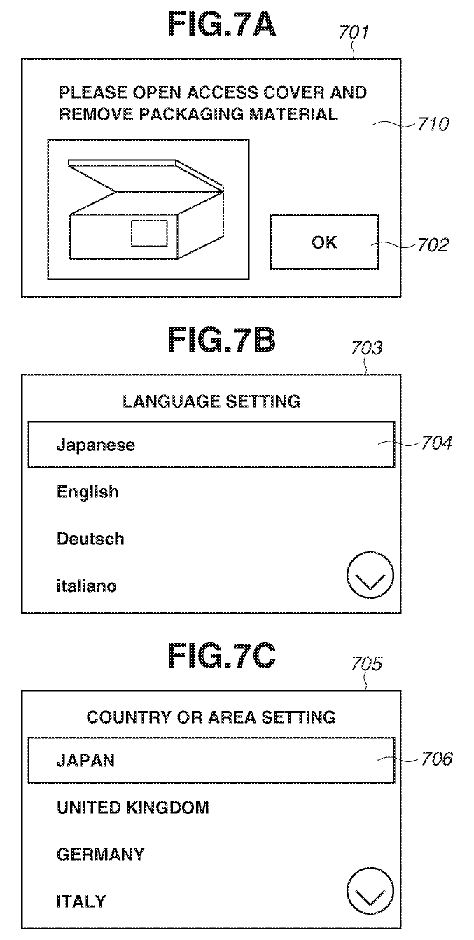

FIG. 7A illustrates an example of a packaging material not-yet-removed notification screen.

As illustrated in FIG. 7A, in the packaging material not-yet-removed notification, a screen 701 for notifying the user of a state where the packaging material 303 is not removed and the necessity of removing the packaging material 303 is displayed. The screen 701 includes a message and image 710 for notifying the user of the state where the packaging material 303 is not removed and the necessity of removing the packaging material 303, and an OK button 702 to be pressed after the user has removed the packaging material 303. Examples of the message for notifying the user of the state where the packaging material 303 is not removed and the necessity of removing the packaging material 303 include a message for instructing the user to open an access cover included in the printer 100. This is because when the access cover is opened, the user can access the movement path of the carriage 301 and can remove the packaging material 303 disposed on the movement path of the carriage 301.

Next, in step S405, the CPU 103 waits until the packaging material 303 is removed by the user. Specifically, the CPU 103 determines whether the packaging material 303 has been removed.

In this determination, the CPU 103 determines that the packaging material 303 has been removed by the user when the OK button 702 illustrated in FIG. 7A is pressed by the user. Alternatively, the CPU 103 may perform a removal determination of the packaging material 303 similar to that in step S403 described above. In addition, when opening/closing of the platen glass 202 of the printer 100 is detected, the CPU 103 may determine that the packaging material 303 has been removed by the user and may perform the removal determination of the packaging material 303 similar to that in step S403 described above.

In step S405 described above, if the CPU 103 determines that the packaging material 303 has not been removed (NO in step S405), the processing returns to step S404. On the other hand, if the CPU 103 determines that the packaging material 303 has been removed (YES in step S405), the processing proceeds to step S406.

In step S406 and subsequent steps, the CPU 103 guides the user to continue performing the initial installation operation related to hardware of the printer 100. Specifically, various print preparation settings are made as image forming settings necessary for image forming processing on the image forming apparatus. Operations for these print preparation settings correspond to setting operations that require at least a physical operation other than a screen operation and a button operation on the printer 100.

Examples of the physical operation other than the screen operation and the button operation on the printer 100 include an operation of opening a cover provided on the printer 100 for ink installation and an operation of opening a sheet cassette provided on the printer 100 for sheet loading. In the first embodiment, processing of steps S406 and S407 to be described below is executed as processing for the initial installation operation related to hardware of the printer 100. However, some of the processing of steps S406 and S407 may be omitted. Further, processing other than the processing of steps S406 and S407 may be executed as the processing for the initial installation operation related to hardware of the printer 100.

In step S406, the CPU 103 displays, on the display unit 105, a screen for prompting the user to perform the ink installation for ink setup. Examples of the screen may include a screen for prompting the user to attach an ink cartridge to the printer 100, and a screen for prompting the user to inject ink into the ink tank 302 provided on the printer 100 from an ink bottle.

Subsequent to completion of the ink installation, in step S407, the CPU 103 displays, on the display unit 105, a screen for prompting the user to load sheets into the sheet feed port 203.

Next, in step S408, the CPU 103 executes print head position adjustment using the set ink and sheets. Specifically, first, the CPU 103 feeds a sheet from the sheet feed port 203 and executes test printing using a predetermined print pattern. Then, a result of the test printing is optically scanned with the scanner unit 107, and an ink ejection timing is optimized based on a result of a scan.

After completion of the print head position adjustment in step S408 described above, the processing proceeds to step S409. In step S409, the CPU 103 sets the value of a hardware arrival complete flag to "ON". The hardware arrival complete flag is stored in the ROM 101 and has a value of either "ON" or "OFF". An initial value of the hardware arrival complete flag is set to "OFF", for example, at the time of factory shipment.

In other words, in step S409 described above, the CPU 103 stores a state where the hardware arrival complete flag is "ON" in the ROM 101. The state where the hardware arrival complete flag is "ON" indicates a hardware arrival complete state where the initial installation operation related to hardware of the printer 100 is completed, or indicates a state where processing for the initial installation operation related to hardware of the printer 100 is completed.

Subsequently, in step S410, the CPU 103 determines whether the printer 100 is in a software arrival complete state. If a software arrival complete flag is "ON", the CPU 103 determines that the printer 100 is in the software arrival complete state. If the software arrival complete flag is "OFF", the CPU 103 determines that the printer 100 is not in the software arrival complete state. The software arrival complete flag is stored in the ROM 101 and has a value indicating either "ON" or "OFF". An initial value of the software arrival complete flag is set to "OFF", for example, at the time of factory shipment.

In step S410 described above, if the CPU 103 determines that the printer 100 is in the software arrival complete state (software arrival complete flag is "ON") (YES in step S410), the processing proceeds to step S418. Processing of step S418 and subsequent steps will be described below.

On the other hand, if the CPU 103 determines that the printer 100 is not in the software arrival complete state (software arrival complete flag is not "ON") (NO in step S410), the processing proceeds to step S411.

In step S411 and subsequent steps, the CPU 103 guides the user to perform the initial installation operation related to software of the printer 100. In other words, the CPU 103 guides the user to make various apparatus settings having no influence on the image forming processing on the image forming apparatus. Operations for these apparatus settings correspond to setting operations that do not involve any physical operation other than the screen operation and the button operation on the printer 100. In the apparatus settings, the CPU 103 guides the user to first perform an operation corresponding to a high-priority item and then perform an operation corresponding to a low-priority item.

In the first embodiment, processing of steps S411 to S415 to be described below is executed as processing for the initial installation operation related to software of the printer 100. However, some of the processing of steps S411 to S415 may be omitted. Further, processing other than the processing of steps S411 to S415 may be executed as the processing for the initial installation operation related to software of the printer 100.

In step S411, the CPU 103 displays a language setting confirmation screen on the display unit 105.

The language setting confirmation screen is displayed on the display unit 105 of the printer 100 as illustrated in FIG. 7B.

FIG. 7B illustrates an example of a language setting confirmation screen 703.

The user can select any language from a list of languages on the language setting confirmation screen 703. Assume herein that Japanese 704 is selected. If the CPU 103 determines that the language is selected on the language setting confirmation screen 703, the processing proceeds to step S412.

In step S412, the CPU 103 displays a country setting confirmation screen on the display unit 105.

The country setting confirmation screen is displayed on the display unit 105 of the printer 100 as illustrated in FIG. 7C.

FIG. 7C illustrates an example of a country setting confirmation screen 705.

The user can select any country or area from a list of countries or areas on the country setting confirmation screen 705. Assume herein that Japan 706 is selected. If the CPU 103 determines that a country or an area is selected on the country setting confirmation screen 705, the processing proceeds to step S413.

In step S413 and subsequent steps, operations corresponding to low-priority items in the initial installation operation related to software of the printer 100 are continued to be performed.

In step S413, the CPU 103 displays, on the display unit 105, a screen for prompting the user to input a network setting for setting a network for the printer 100. Specific examples of the screen include a screen for selecting a type of network connection to be set for the printer 100. In other words, the screen is a screen for selecting a type of interface to be used for the network connection for the printer 100. As options, for example, a wired local area network (LAN) connection, a wireless LAN connection, and a universal serial bus (USB) connection are displayed. When any of the options is selected, a screen for establishing the connection corresponding to the selected option is displayed.

Subsequent to completion of the network setting, in step S414, the CPU 103 displays, on the display unit 105, a screen for prompting the user to input a license to use a web service on the printer 100.

Next, in step S415, the CPU 103 displays, on the display unit 105, a screen for prompting the user to input information indicating whether to enable a setting for automatically updating the firmware when the firmware of the printer 100 is not the latest version.

After completion of the automatic update setting in step S415, in step S416, the CPU 103 sets the value of the software arrival complete flag to "ON". In other words, the CPU 103 stores a state where the software arrival complete flag is "ON" in the ROM 101. The state where the software arrival complete flag is "ON" indicates the software arrival complete state where the initial installation operation related to software of the printer 100 is completed, or indicates a state where processing for the initial installation operation related to software of the printer 100 is completed.

Subsequently, in step S417, the CPU 103 determines whether the printer 100 is in the hardware arrival complete state (the hardware arrival complete flag is "ON").

If the CPU 103 determines that the printer 100 is not in the hardware arrival complete state (the hardware arrival complete flag is not "ON") (NO in step S417), the processing returns to step S406.

On the other hand, in step S417, if the CPU 103 determines that the printer 100 is in the hardware arrival complete state (the hardware arrival complete flag is "ON") (YES in step S417), the processing proceeds to step S418.

In step S418, the CPU 103 determines that the initial installation operation for the printer 100 is fully completed, and enables the sheet set detection state. In other words, the sheet set detection state disabled in step S402 is enabled.

Subsequently, in step S419, the CPU 103 sets the initial installation state flag to "OFF", and the processing in this flowchart ends.

In the configuration according to the first embodiment, it is recommended to remove the packaging material 303 before initial start-up of the printer 100, and priority can be given to guiding the user to remove the packaging material 303 in a case where the packaging material 303 is not removed. Then, subsequent to guiding of the user to remove the packaging material 303, the user is guided to perform the print preparation settings that require a physical operation, so that the print preparation settings that require a physical operation and the apparatus settings that do not involve any physical operation can be separated regardless of the user's operation status. The first embodiment is effective particularly when the manufacturer of the image forming apparatus can perform the language setting to a desired language for each user in advance. In other words, the first embodiment is effective particularly in a case where there is no problem in executing guiding of the user to remove the packaging material 303 with higher priority over the language setting. A case where the language setting is to be prioritized over removing of the packaging material 303 will be described in a second embodiment.

In addition, in the first embodiment, the processing branches at steps S410 and S417 based on two flags, namely, the software arrival complete flag and the hardware arrival complete flag, which are stored in the ROM 101. This is effective in preventing the same setting from being performed a plurality of times when the user once terminates the printer 100 before completion of the initial installation operation. For example, when the printer 100 is once terminated in the state where the hardware arrival complete flag is "ON" and is started again, it is possible to prevent the print preparation settings for the printer 100 from being performed again. Also, in this case, the print preparation settings and the apparatus settings can be separated regardless of the user's operation status.

As described above, in the first embodiment, whether the packaging material 303 is present inside the image forming apparatus is determined, and based on a result of the determination, control is performed to switch (change) an order of guidance for the initial installation operation for the image forming apparatus. Consequently, in the initial installation operation for the printer 100, the print preparation settings that require the physical operation on the image forming apparatus and the apparatus settings that do not involve any physical operation can be executed separately. Further, by switching which of the two is executed first in accordance with the user's installation status, it is possible to smoothly complete the initial installation operation while reducing a sense of awkwardness in operation.

### Second Embodiment

In the first embodiment described above, the configuration has been described in which the print preparation settings and the apparatus settings are executed separately in accordance with the removal status of the packaging material 303. In the second embodiment, in addition to the configuration according to the first embodiment, a configuration will be described in which an execution order of the print preparation settings and the apparatus settings is switched in accordance with a completion status of high-priority software settings.

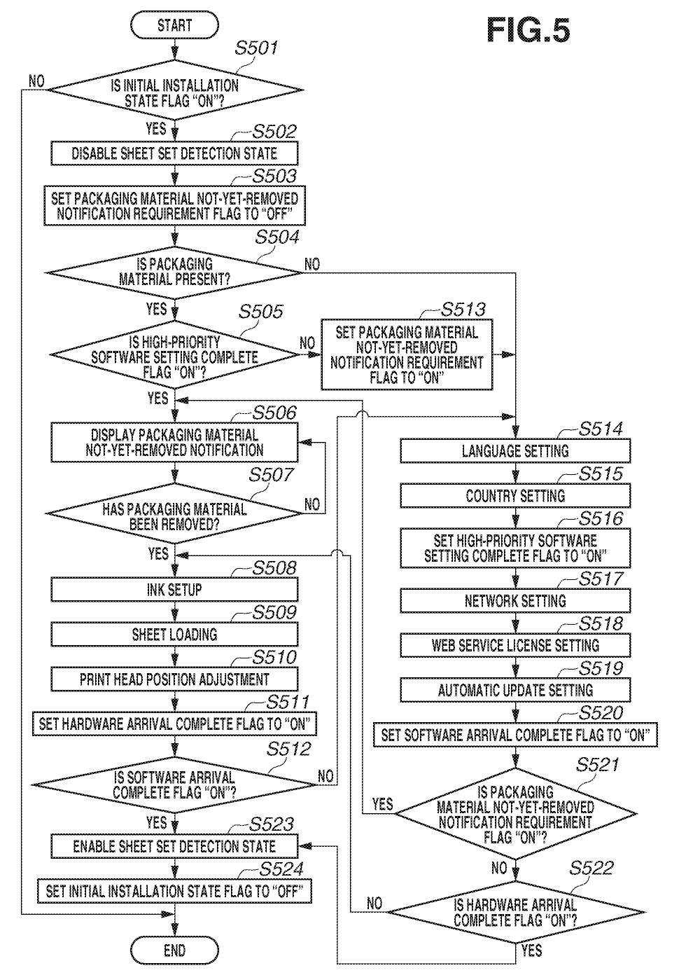

Note that a configuration of each device according to the second embodiment is similar to that of the first embodiment unless otherwise specified, and the description thereof is omitted. The initial installation processing is illustrated in FIG. 4 in the first embodiment, whereas initial installation processing according to the second embodiment is illustrated in FIG. 5.

### Initial Installation Processing

FIG. 5 is a flowchart illustrating an example of the initial installation processing to be executed by the printer 100 according to the second embodiment. A series of processes illustrated in the flowchart of FIG. 5 is performed by the CPU 103 of the printer 100 loading a program code stored in the ROM 101 or the like into the RAM 102 and executing the program code. The processing in this flowchart is performed at a timing when the user turns on the power after purchasing the printer 100 and opening the package thereof.

Note that steps S501 and S502 illustrated in FIG. 5 are the same as steps S401 and S402 illustrated in FIG. 4, respectively, and thus description thereof is omitted. In addition, step S504 illustrated in FIG. 5 is the same as step S403 illustrated in FIG. 4, and thus description thereof is omitted.

Further, steps S506 to S512 illustrated in FIG. 5 are the same as steps S404 to S410 illustrated in FIG. 4, respectively, and thus description thereof is omitted. Steps S514 and S515 illustrated in FIG. 5 are the same as steps S411 and S412 illustrated in FIG. 4, respectively, and thus description thereof is omitted. Steps S517 to S520 illustrated in FIG. 5 are the same as steps S413 to S416 illustrated in FIG. 4, respectively, and thus description thereof is omitted. Steps S523 and S524 illustrated in FIG. 5 are the same as steps S418 and S419 illustrated in FIG. 4, respectively, and thus description thereof is omitted.

Subsequent to the processing of step S502, in step S503, the CPU 103 sets a packaging material not-yet-removed notification requirement flag to "OFF". The packaging material not-yet-removed notification requirement flag may be configured to be stored in the ROM 101, or may be configured to be temporarily held in the RAM 102. In the second embodiment, the packaging material not-yet-removed notification requirement flag is set to "OFF" as initialization processing at start-up of the printer 100, and then the processing proceeds to step S504.

If the CPU 103 determines that the packaging material 303 is present (is not removed) (YES in step S504), the processing proceeds to step S505. In step S505, the CPU 103 determines whether the high-priority software setting is performed (a high-priority software setting complete flag is "ON").

If the high-priority software setting complete flag is "ON" (YES in step S505), the processing proceeds to step S506, and the processing of steps S506 to S512 is executed.

On the other hand, if the high-priority software setting complete flag is not "ON" (NO in step S505), the processing proceeds to step S513.

In step S513, the CPU 103 sets the packaging material not-yet-removed notification requirement flag to "ON", and then the processing proceeds to step S514.

The CPU 103 performs the language setting in step S514 and the country setting in step S515, and then the processing proceeds to step S516.

In step S516, the CPU 103 sets the high-priority software setting complete flag to "ON". In other words, the CPU 103 stores that the high-priority software setting complete flag is "ON" in the ROM 101. Subsequent to the processing of step S516, the processing proceeds to step S517. Further, the CPU 103 executes processing of steps S517 to S520, and then the processing proceeds to step S521.

In step S521, the CPU 103 determines whether the printer 100 is in a packaging material not-yet-removed notification requirement state.

If the packaging material not-yet-removed notification requirement flag is "ON" (YES in step S521), the processing returns to step S506.

On the other hand, if the packaging material not-yet-removed notification requirement flag is not "ON" (NO in step S521), the processing proceeds to step S522.

In step S522, the CPU 103 determines whether the printer 100 is in the hardware arrival complete state (the hardware arrival complete flag is "ON").

If the printer 100 is not in the hardware arrival complete state (hardware arrival complete flag is "OFF") (NO in step S522), the processing returns to step S508.

On the other hand, if the printer 100 is in the hardware arrival complete state (hardware arrival complete flag is "ON") (YES in step S522), the processing proceeds to step S523.

Then, after the CPU 103 executes processing of steps S523 and S524, the processing in this flowchart ends.

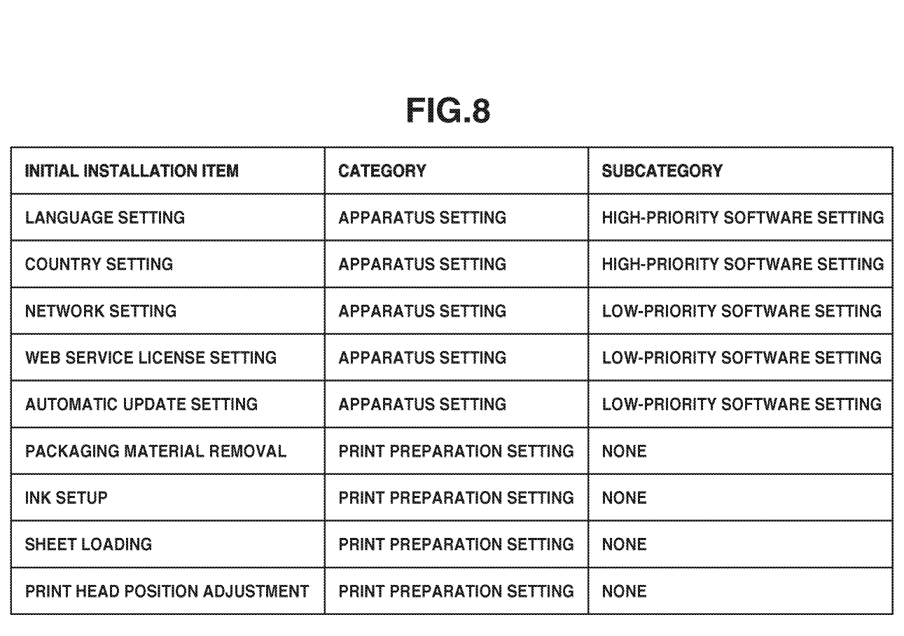

According to the second embodiment, in the initial installation operation, categories for the print preparation settings that require a physical operation on the printer 100 and categories for the apparatus settings that do not involve any physical operation are set as illustrated in FIG. 8.

In addition, among the apparatus settings, categories for items (with the high-priority software setting) to be performed with higher priority over the print preparation settings and categories for each item (with the low-priority software setting) to be performed with lower priority over the print preparation settings are also set as illustrated in FIG. 8.

FIG. 8 is a table illustrating an example of operation categories for the items of the initial installation processing according to the second embodiment.

Although management using high-priority and low-priority flags and setting of subcategories are not performed, the concept of priority also exists in the print preparation settings. Specifically, since the carriage 301 cannot be moved to a position where ink setup can be performed when the packaging material 303 is not removed, it is necessary to remove the packaging material 303 before the ink setup. Further, in order to perform the print head position adjustment, it is necessary that the ink setup and sheet loading have been completed. The order of guidance for the print preparation settings in the flowchart according to the second embodiment is determined in consideration of such priority of the print preparation settings.

Categories of priorities of the software settings illustrated in FIG. 8 are determined as follows.

The language setting is designated as a high-priority software setting because, depending on a shipment destination area of the printer 100, the manufacturer of the image forming apparatus may be unable to perform the language setting in advance to a language desired by each user. Accordingly, for example, there may be a case where the printer 100 starts up in English at an initial start-up even though the user uses Italian. In such a situation, if the initial installation is performed while the language remains English, it is difficult for the user unfamiliar with English to smoothly complete the initial installation. For example, even when guidance for removing the packaging material 303 is displayed, the user may not be able to understand a specific removal method from sentences in English, so that the user cannot remove the packaging material 303. For this reason, it is important to prompt the user to perform the language setting first to display screens for the subsequent initial installation operation in the language selected by the user. The country setting, which is an item to be subsequently set, does not necessarily have high priority, but is classified as the high-priority software setting since the item is closely related to the language. Thus, it is also possible to configure such that only the language setting is classified as the high-priority software setting, and the country setting is classified as the low-priority software setting. Depending on a shipment destination area of the printer 100, the manufacturer of the image forming apparatus may be able to perform the language setting in advance to a language desired by each user. For example, there is a case where an initial setting is set to Japanese because the printer 100 is shipped to an area where most users use Japanese. Under such a situation, there may be a case where there is no need to check the language setting during the initial installation, i.e., there is no item to be classified as the high-priority software setting. An embodiment to be implemented in such a case will be described as a third embodiment.

In the second embodiment, the configuration is employed in which the determination as to whether the packaging material 303 has been removed in step S504 is performed every time the initial installation processing illustrated in FIG. 5 is executed. However, a configuration may be employed in which the determination is performed in a subsequent execution only when it has not been determined that the packaging material 303 has been removed (i.e., when it is determined that a packaging material is present). In such a configuration, a flag for storing information indicating whether the packaging material 303 has been removed can be stored in the ROM 101. The flag for storing the information indicating whether the packaging material 303 has been removed is configured such that it is set to "OFF" in an initial state at the time of factory shipment and to "ON" when it is determined that the packaging material 303 has been removed in step S507.

Also, in the determination in step S521, branching may be determined using the flag for storing the information indicating whether the packaging material 303 has been removed. Specifically, if the flag for storing the information indicating whether the packaging material 303 has been removed is "ON", the processing proceeds to step S522. If the flag is "OFF", the processing proceeds to step S506. When this configuration is employed, the packaging material not-yet-removed notification requirement flag may be excluded from the configuration according to the second embodiment.

As described above, according to the second embodiment, in the initial installation operation for the printer 100, the print preparation settings and the apparatus settings can be executed separately. Further, by switching which of the two is executed first in accordance with the user's installation status, it is possible to smoothly complete the initial installation operation while reducing a sense of awkwardness in operation perceived by the user.

### Third Embodiment

In the second embodiment described above, the configuration has been described in which the execution order of the print preparation settings and the apparatus settings is switched in accordance with the removal status of the packaging material 303 and the completion status of the high-priority software settings.

In the third embodiment, in addition to the configuration according to the second embodiment, a configuration will be described in which execution or non-execution of the high-priority software settings is additionally switched in accordance with the completion status of the high-priority software setting.

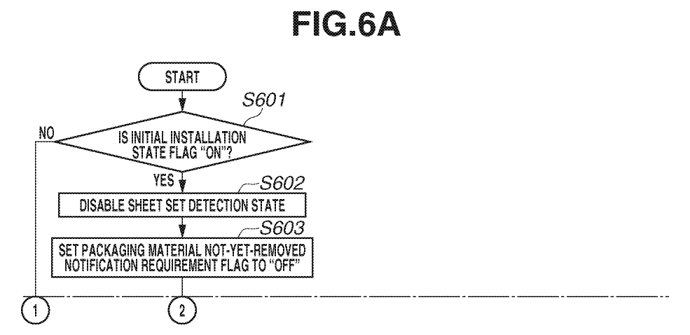

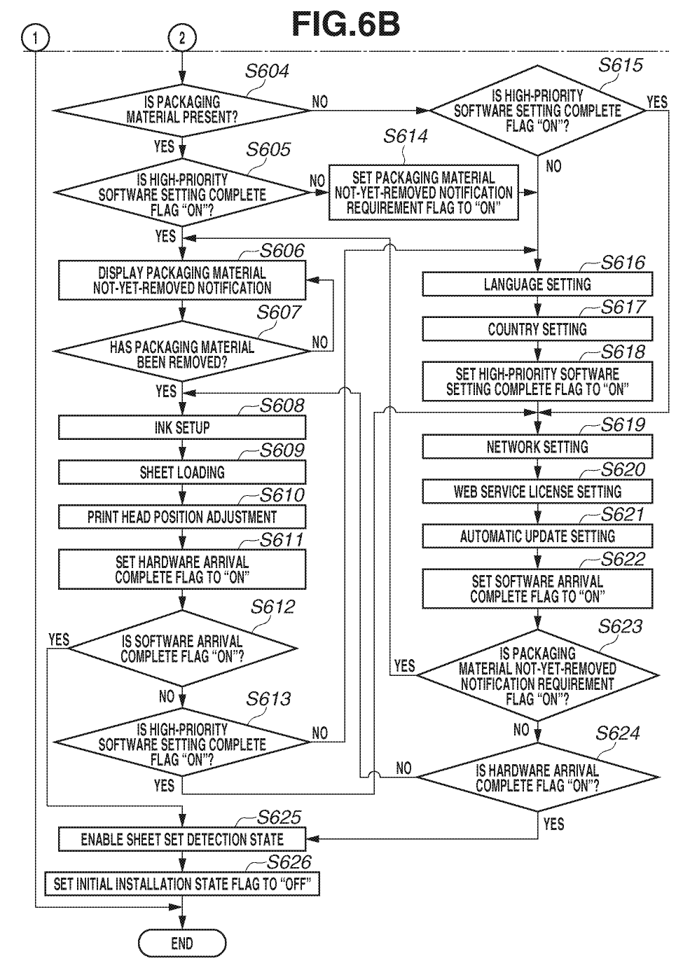

Note that a configuration of each device according to the third embodiment is similar to that of the second embodiment unless otherwise specified, and the description thereof is omitted. The initial installation processing is illustrated in FIG. 5 in the second embodiment, whereas initial installation processing according to the third embodiment is illustrated in FIGS. 6A and 6B.

### Initial Installation Processing

FIGS. 6A and 6B are a flowchart illustrating an example of the initial installation processing to be executed by the printer 100 according to the third embodiment. A series of processes illustrated in the flowchart of FIGS. 6A and 6B is performed by the CPU 103 of the printer 100 loading a program code stored in the ROM 101 or the like into the RAM 102 and executing the program code. The processing in this flowchart is performed at a timing when the user turns on the power after purchasing the printer 100 and opening the package thereof.

Note that steps S601 to S612 illustrated in FIG. 6 are the same as steps S501 to S512 illustrated in FIG. 5, respectively, and thus description thereof is omitted. In addition, step S614 illustrated in FIG. 6 is the same as step S513 illustrated in FIG. 5, and thus description thereof is omitted. Further, steps S616 to S626 illustrated in FIG. 6 are the same as steps S514 to S524 illustrated in FIG. 5, respectively, and thus description thereof is omitted.

In step S613, the CPU 103 determines whether the high-priority software setting is performed (a high-priority software setting complete flag is "ON").

If the high-priority software setting complete flag is "ON" (YES in step S613), the processing proceeds to step S619.

On the other hand, if the high-priority software setting complete flag is not "ON" (NO in step S613), the processing proceeds to step S616.

Further, in step S604, if the CPU 103 determines that the packaging material 303 is not present (has been removed) (NO in step S604), the processing proceeds to step S615.

In step S615, the CPU 103 determines whether the high-priority software setting is performed (the high-priority software setting complete flag is "ON").

If the high-priority software setting complete flag is "ON" (YES in step S615), the processing proceeds to step S619.

On the other hand, if the high-priority software setting complete flag is not "ON" (NO in step S615), the processing proceeds to step S616.

Then, after the CPU 103 executes processing of steps S616 to S626, the processing in this flowchart ends.

By the branching in steps S613 and S615, it becomes possible to prevent the high-priority software setting from being performed again when the high-priority software setting has already been performed after completion of the print preparation settings or at the start of the apparatus settings. Consequently, it becomes possible to provide guidance for removing the packaging material 303 with high priority when the packaging material 303 has not been removed while avoiding performing the high-priority software setting a plurality of times.

As described above, according to the third embodiment, in the initial installation operation for the printer 100, the print preparation settings and the apparatus settings can be executed separately. Further, by switching which of the two is executed first in accordance with the user's installation status, it is possible to smoothly complete the initial installation operation while reducing a sense of awkwardness in operation.

### Fourth Embodiment

In the first to third embodiments described above, description has been provided using the configuration in which the user removes the packaging material 303. However, instead of the configuration in which the user manually removing the packaging material 303, a configuration may be employed in which a lock mechanism is released by a hardware operation of the printer 100.

Specifically, a configuration is employed in which the lock mechanism is provided to protect each print head and the carriage 301 from vibration and impact during delivery of the printer 100, and the printer 100 itself performs an operation of releasing the lock mechanism at start-up of the initial installation. In this case, it is conceivable that the printer 100 itself may be unable to release the lock mechanism due to an unforeseen circumstance. In such a case, it is conceivable that the user may manually release the lock mechanism. In such a configuration, step S405 according to the first embodiment can be replaced with a determination "has the lock mechanism been released?". Further, step S404 can be replaced with "lock mechanism release notification", and step S405 can be replaced with "has lock mechanism release operation been performed?". Accordingly, with respect to the packaging material 303, the configuration of the lock mechanism that can be released by a hardware operation of the printer 100 may be employed.

In the related art, the status of the initial installation operation is displayed; however, it has not been possible to provide appropriate guidance in accordance with an operation status of an operator performing the initial installation. In addition, in the related art, no consideration has been given to separation between print preparation settings that require a physical operation on the image forming apparatus and apparatus settings that do not involve any physical operation. Thus, particularly in a case where the user performs the initial installation by himself/herself, the user performs the operation while having no knowledge and, in light of the user's own experience, performs the operation while assuming an order of items in which the user is generally guided. Such a user would assume, for example, that the user would be instructed to perform the print preparation settings that require a physical operation on the image forming apparatus and the apparatus settings that do not involve any physical operation separately, or that the user would be guided to perform related settings in succession. However, if the user is guided to perform the initial settings in an order inconsistent with the user's assumption, the user may attempt to forcibly find an association or may perform an operation different from the operation the user is guided to perform. In other words, as in the related art, if the print preparation settings and the apparatus settings are not separated and the user is guided to alternately perform the print preparation settings and the apparatus settings, there is a possibility that the user cannot smoothly perform the initial installation operation.

On the other hand, in the embodiments described above, in the initial installation operation for the printer 100, the print preparation settings that require a physical operation on the image forming apparatus and the apparatus settings that do not involve any physical operation can be executed separately. Further, which of the two is executed first can be switched in accordance with the user's installation status. Consequently, it is possible to smoothly complete the initial installation operation while reducing a sense of awkwardness in operation perceived by the operator.

As described above, according to the embodiments, in the initial installation operation for the printer 100, the print preparation settings and the apparatus settings can be executed separately. Further, which of the two is executed first can be switched in accordance with the user's installation status. Consequently, it is possible to smoothly complete the initial installation operation while reducing a sense of awkwardness in operation perceived by the operator.

Note that the configuration and contents of various data described above are not limited thereto, and the data may have various configurations and contents according to the intended use and purpose.

While the embodiments are described above, the present disclosure can also be applied to, for example, a system, an apparatus, a method, a program or a storage medium, and the like as embodiments. Specifically, the present disclosure may be applied to a system composed of a plurality of devices, or may be applied to an apparatus composed of a single device.

In addition, configurations obtained by combining the above-described embodiments are all included in the embodiments of the present disclosure.

According to the present disclosure, it is possible to smoothly complete the initial installation operation while reducing a sense of awkwardness in operation perceived by the operator.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-049102, filed March 24, 2025, which is hereby incorporated by reference herein in its entirety.

What is claimed is:

1. An image forming apparatus comprising:
at least one memory that stores a set of instructions; and
at least one processor that executes the instructions causing the image forming apparatus to perform operations comprising:
a first determination unit configured to determine whether a packaging material is present inside the image forming apparatus; and
a control unit configured to control an order of guidance for an initial installation operation for the image forming apparatus in accordance with a result of determination,
wherein the initial installation operation includes a first operation related to hardware and a second operation related to software, and
wherein, in a case where the packaging material is present inside the image forming apparatus, the control unit guides a user to perform the second operation subsequent to performing removal of the packaging material and the first operation and, in a case where the packaging material is not present inside the image forming apparatus, the control unit guides the user to perform the first operation subsequent to performing the second operation.

2. The image forming apparatus according to claim 1, wherein, in a case where the removal of the packaging material and the first operation are performed, the control unit guides the user to perform the first operation in succession after the removal of the packaging material.

3. The image forming apparatus according to claim 1, wherein the first operation includes an operation of performing a setting for image forming processing on the image forming apparatus.

4. The image forming apparatus according to claim 1, wherein the second operation includes an operation of performing a setting having no influence on image forming processing on the image forming apparatus.

5. The image forming apparatus according to claim 1,
wherein the first operation includes at least one of an operation of setting a recording material, an operation of setting a sheet, and an operation of adjusting a print head, and
wherein the second operation includes an operation of setting a language.

6. The image forming apparatus according to claim 1, wherein, in a case where the packaging material is present inside the image forming apparatus, the control unit displays a screen for guiding the user to perform the second operation subsequent to performing the removal of the packaging material and the first operation, and in a case where the packaging material is not present inside the image forming apparatus, the control unit displays a screen for guiding the user to perform the first operation subsequent to performing the second operation.

7. The image forming apparatus according to claim 1, wherein a screen for guiding the user to remove the packaging material includes a message for notifying the user that the packaging material has not been removed, and a button to be pressed by the user after the user removes the packaging material.

8. The image forming apparatus according to claim 1, wherein the first operation is an operation of opening a cover or a sheet cassette provided on the image forming apparatus.

9. The image forming apparatus according to claim 1, further comprising a second determination unit configured to determine whether the image forming apparatus is in an initial installation state.

10. The image forming apparatus according to claim 9, wherein, in a case where the second determination unit determines that the image forming apparatus is in the initial installation state, a sheet set detection state is disabled.

11. The image forming apparatus according to claim 1, wherein the first determination unit determines whether the packaging material is present inside the image forming apparatus based on an operation of a carriage.

12. The image forming apparatus according to claim 1, wherein the image forming apparatus is an inkjet printer.

13. A control method for an image forming apparatus, the control method comprising:
determining whether a packaging material is present inside the image forming apparatus; and
controlling an order of guidance for an initial installation operation for the image forming apparatus in accordance with a result of determination,
wherein the initial installation operation includes a first operation related to hardware and a second operation related to software, and
wherein, the controlling includes, in a case where the packaging material is present inside the image forming apparatus, guiding a user to perform the second operation subsequent to performing removal of the packaging material and the first operation and, in a case where the packaging material is not present inside the image forming apparatus, guiding the user to perform the first operation subsequent to performing the second operation.

14. A non-transitory computer-readable storage medium storing instructions that, when executed by a computer, cause the computer to perform a control method for an image forming apparatus, the control method comprising:
determining whether a packaging material is present inside the image forming apparatus; and
controlling an order of guidance for an initial installation operation for the image forming apparatus in accordance with a result of determination,
wherein the initial installation operation includes a first operation related to hardware and a second operation related to software, and
wherein, the controlling includes, in a case where the packaging material is present inside the image forming apparatus, guiding a user to perform the second operation subsequent to performing removal of the packaging material and the first operation and, in a case where the packaging material is not present inside the image forming apparatus, guiding the user to perform the first operation subsequent to performing the second operation.
